(19) United States
(12) Patent Application Publication
(10) Pub. No.: US 2014/0040786 A1
(43) Pub. Date: Feb. 6, 2014

(54) AUTOMATIC TRACKING OF USER ENGAGEMENT WITH COMPUTING INTERFACES

(71) Applicant: KeyMetric, Inc., Seattle, WA (US)

(72) Inventors: Gregory Earl Swanson, Fuquay Varina, NC (US); Michael William Turta, Bellevue, WA (US); Antoinette Lynn Hume, Aurora, CO (US)

(73) Assignee: KeyMetric, Inc., Seattle, WA (US)

(21) Appl. No.: 13/957,208

(22) Filed: Aug. 1, 2013

Related U.S. Application Data
(60) Provisional application No. 61/678,116, filed on Aug. 1, 2012.

(51) Int. Cl. G06F 3/0484

(52) U.S. Cl. CPC G06F 3/0484
USPC 715/760

(57) ABSTRACT

An engagement tracking system is described herein that automatically scans, identifies, and tags available events to track, monitor, record, and report on various unique webpages and/or electronic/digital content sources for any domain(s) designated by a user. The system eliminates the need for manual tagging/coding yet allows users to easily administer the tracking, monitoring, recording, and reporting of events through a hosted user interface or through an integrated third-party reporting application. In some embodiments, the system automatically scans and identifies text-based telephone numbers, image-based telephone numbers, and call-to-action images to alter the content and images to generate a URI/hypertext reference in order to initiate a telephone call (either through dialing protocols or third-party software). Each URI/hypertext reference is then tagged to track, monitor, record, and report as with other events managed by the system.

### CROSS-REFERENCE TO RELATED APPLICATIONS

The present application claims the benefit of U.S. Provisional Patent Application No. 61/678,116 (Attorney Docket No. KEYMETRIC01) entitled “AUTOMATIC TRACKING OF USER ENGAGEMENT,” and filed on Aug. 1, 2012, which is hereby incorporated by reference.

### BACKGROUND

Tracking the ways that consumers interact with a business has often been a challenge for businesses. Businesses analyze this information to find ways to increase consumer engagement, to determine whether advertising is working, to determine how costs are distributed to advertisers, and for many other actions. The process of associating a particular user activity with actions of the business is often a manual and time-consuming one. For example, a business that wants to track the effectiveness of a print or online advertisement at causing consumers to call the business may create a designated toll free number, email address, or other unique contact point just for connecting the consumer contact with the manner in which the consumer discovered the business.

According to recent industry studies, approximately 20% of all website and Internet content page views worldwide originate from mobile devices and appliances, and this number is constantly increasing. It comes as no surprise then that a recent study documented that 92% of organizations surveyed expressed the need to incorporate mobile analytics and tracking in order to improve business, sales, and advertising process efficiencies while eliminating unnecessary cost.

At the most basic level, current solutions track and report the way in which visitors initially access and view websites, webpages, and other online content from mobile devices such as smartphones and wireless tablets. However, such solutions generally do not perform tracking, monitoring, recording, and reporting real-time activity at the engagement level, including outbound telephone calls and other digital events such as email sends, forms submissions, downloads, video views, and further engagement activity that originates from and/or is fulfilled on a mobile device. This lack of insight into how visitors are engaging a business or entity, beyond page-level visits and viewings, forces critical decisions to be made based on hypotheses rather than statistical fact.

Furthermore, existing systems lack an ability to automatically identify and/or alter text-based and/or image-based telephone numbers and/or other text-based and/or image-based events and actions into actionable and trackable events (clickable uniform resource identifiers (URIs)/hypertext references) without the installation and/or inclusion of an executable software application on the mobile device. Hence, businesses cannot accurately track, monitor, record, and report how visitors communicate with and engage their websites, webpages, Internet content, and business beyond page-level visits and viewings without extensive application development and/or time-consuming manual tagging of events. Manual tagging of events constrains someone to manually identify and tag the events to be tracked, monitored, recorded, and reported on every unique webpage and/or electronic/digital content source, in most cases making the process for tracking, monitoring, recording, and reporting events and activity extremely time consuming, costly and prone to error.

### BRIEF DESCRIPTION OF THE DRAWINGS

FIG. 1 is a block diagram that illustrates components of the engagement tracking system, in one embodiment.

FIG. 2 is a flow diagram that illustrates processing of the engagement tracking system to automatically tag interaction events in a web page, in one embodiment.

FIG. 3 is a flow diagram that illustrates processing of the engagement tracking system to track telephone calls made in response to a web page, in one embodiment.

FIG. 4 is a flow diagram that illustrates processing of the engagement tracking system to record an interaction that occurs after a web page has been automatically tagged to track interaction events, in one embodiment.

FIG. 5 is a display diagram that illustrates a dashboard of the engagement tracking system, in one embodiment.

FIG. 6 is a display diagram that illustrates a sample report generated by the engagement tracking system, in one embodiment.

FIG. 7 is a display diagram that illustrates a sample list of events generated by the engagement tracking system, in one embodiment.

FIG. 8 is a display diagram that shows a working example of how WebRTC might be used in a website to initiate a phone call directly in the browser itself, in one embodiment.

### DETAILED DESCRIPTION

An engagement tracking system is described herein that automatically scans, identifies, and tags available events to track, monitor, record, and report on various unique webpages and/or electronic/digital content sources for any domain(s) designated by a user. The system eliminates the need for manual tagging/coding yet allows users to easily administer the tracking, monitoring, recording, and reporting of events through a hosted user interface or through an integrated third-party reporting application. In some embodiments, the system automatically scans and identifies text-based telephone numbers, image-based telephone numbers, and call-to-action images to alter the content and images to generate a URI/hypertext reference in order to initiate a telephone call (either through dialing protocols or third-party software). Each URI/hypertext reference is then tagged to track, monitor, record, and report as with other events managed by the system.

The engagement tracking system is particularly well suited to mobile devices and appliances, but can also be applied to desktop or other computers or appliances to track, monitor, record, and report visitor activity and events within these environments. The engagement tracking system allows for the tracking of telephone calls and online events and conversions from mobile and desktop devices and appliances without the need for additional phone numbers or manual event-tracking implementation. This provides businesses with an incredible level of insight into customer engagement with a minimal amount of effort on the part of the business (e.g., information technology (IT) personnel or others).

The engagement tracking system tracks, monitors, records, and reports outbound telephone calls and other digital events and actions that originate from and/or are fulfilled on a mobile device, desktop computer, portable computer, appliance, or other electronic device capable of accessing and presenting electronic digital content. The system connects these events and actions with the originating or referring content, advertising, or further sources such as search engines, domains, social networks, electronic advertisements, emails, campaigns, ad groups, keywords, search queries, telephony carrier, service provider, mobile device manufacturer and model, device browser type and version, physical location, geographical data, demographical data, network location from where a visitor originated, or other information associated with the events.

The engagement tracking system automatically scans and identifies electronic events or event references, such as URIs or hypertext references, submit buttons, and document/file extensions (e.g., for downloads). Upon identifying events, the system tags these events with actionable tracking scripts (e.g., via JavaScript) with either internal logic or an integrated third-party application that allows the system to track, monitor, record, and report the events in combination with other data recorded through a visitor's web browser, acquired through analysis of the URI, detected from server variables such as referrer, and first- or third-party cookies. The system reports event data via a hosted user interface using static and modifiable reporting formats, and/or further via a remote third-party server and/or third-party reporting applications such as Google Analytics, and/or via further format such as a downloadable data file, text-to-voice message, email, third-party application integration, web service application programming interface (API), or other methods.

In some embodiments, the engagement tracking system automatically scans and identifies text-based and/or image-based telephone numbers and/or calls-to-action and tags these elements with actionable tracking scripts (e.g., via JavaScript). The scripts allow the system to monitor, record, and report the events in combination with other data recorded through a visitor's web browser using proprietary first or third party cookies and transmitted to remote systems. For visitors using mobile devices that do not inherently alter a text-based or image-based telephone number and text-based or image based events to a clickable (and thus trackable) event, the system alters a text-based telephone number to a clickable URI/hypertext reference, allowing visitors to execute an outbound telephone call without the need for manually dialing the telephone number. For mobile devices that already inherently alter a text-based telephone number to a clickable event, the system proceeds with tagging this event with a tracking script. Once text and/or image-based phone numbers have been, or are inherently, clickable events, the system tags the event with a tracking script to track, monitor, record, and report via a hosted user interface and/or an integrated third-party application.

Previous tracking systems often operated in desktop or laptop environments that lacked any integrated telephony capability. Users often performed actions related to engaging with a business on a variety of devices in a manner that made tracking difficult. For example, a user might find a phone number on a website from the user's desktop computer, then pick up a separate phone and dial the number in a manner that was not trackable or connectable with the initial engagement through the website. On modern mobile devices, Internet browsing, emailing, placing phone calls, and other activities often all happen on the same device in a manner that is trackable. Moreover, cloud-based computing and other systems used in conjunction with today's mobile devices often provide a useful level of synchronization, such that even when actions are performed on separate devices, the synchronization software can make associations between the events. The engagement tracking system can leverage all of this information to provide a comprehensive report of user engagement with a business.

The engagement tracking system can augment prior manual or non-telephonic systems to scan, identify, and replace text-based telephone number(s) with unique and traceable text-based local or toll-free telephone numbers that, when combined with other data recorded through a visitor's web browser, shall connect these events and actions with the originating and/or referring content, advertising, or further sources such as search engines, referring domains, ad sources and campaigns, social networks, digital advertisements, videos, emails, keywords, search queries, operating system, and browser type and version from where a visitor originated. The system extends this capability to scan its systems data for active/in-progress telephone calls, and/or a time-stamp that indicates the initiation time of a telephone call, and in combination with other data recorded through a visitor's web browser and session, can initiate a remote procedure call from the web browser containing a unique URI that will associate the telephone call to a unique visitor session in order to track session-specific data such as click-stream, referring domain, ad and traffic source, keyword, search query, and further data to determine which webpage or content URI was active when the telephone call initiated—thereby taking advantage of data available only on the visitor's web browser, including settings and cookies.

Furthermore, as within the mobile device environment, the system scans and identifies text-based and/or image-based telephone numbers and tag these events with actionable scripts that allow the system to monitor, record, and report the events in combination with other data recorded through a visitor's web browser using first or third-party cookies and remote procedure calls to transmit data to remote servers. Additionally the system can integrate with third-applications, such as SKYPE, LivePerson, ZiffTalk, and so forth, which may be installed as executable software programs and/or script-based functions that allow visitors within the desktop environment to initiate telephone calls without the need to manually dial a telephone number. As with certain mobile environments, third-party applications such as Skype often modify phone numbers on the page to be links that initiate a calling process. The engagement tracking system can similarly tag events on these links to allow calls initiated in such cases to be tracked like other on-page events.

The following terms are used herein and are introduced here with their common definitions.

Phone Call Protocol—link protocol used to initiate a phone call on a device. Various protocols may be used to initiate phone calls, though some may be non-standard or unrecognized by the Internet Assigned Numbers Authority (IANA) (e.g., tel:, call:, skype:, and so on).

Optical Character Recognition (OCR)—The mechanical or electronic conversion of scanned images of handwritten, typewritten, or printed text into machine-encoded text.

Regular Expression—A regular expression is a set of pattern matching rules encoded in a string according to certain syntax rules that allow determining whether a particular subject text string matches the pattern.

Anchor Tag—The hypertext markup language (HTML) code for creating a link to another page or entity on the Internet. An anchor tag can also initiate an application or event through various protocols.

Auto-Event-Tagging

The engagement tracking system performs auto-event-tagging to automatically link into events on a webpage to track events without the manual addition of code for individual events, links, forms, and so forth. Online events can be associated with individual website visitors, thereby detecting vital information including the traffic source, advertising source, campaign, keyword, referring domain, search query, and further. By parsing the page contents, the system identifies interactive elements and adds tracking code dynamically to those elements. This allows the system to track any events on the webpage without burdening the web page author or other business personnel with manually hooking various events for tracking. In addition, through custom configuration via the user interface, individual events can be renamed and/or ignored if a particular business using the system wants a finer degree of control over what and how events are tracked. Tracking code may comprise adding a JavaScript function call to identified events, such as a click event of URIs or hypertext references, click event of buttons, click event of images, or submit event of forms. This may involve the addition of these events to the page elements, or it may involve appending additional JavaScript to an already existing event script, which the system can perform.

Text-Based Telephone Number Identification

Comparing text within a webpage to known international phone number formats can identify text-based telephone numbers. This can be accomplished through simple string matching, regular expressions, or other similar technology for finding specific character patterns within the web page content. By identifying the telephone number, the engagement tracking system finds the telephone number content for link enabling (including formatting) and extracts the destination phone number for the appropriate phone call protocol. A variety of phone number formats could exist on various webpages and/or content sources or even within a single webpage and/or content source. The system can identify some or all of these for link enabling.

Link-Enabling Telephone Numbers

In a standard desktop environment, telephone numbers are not an interactive webpage element. However, in the mobile environment, they can be an interactive event due to integrated telephony capability. A click on a telephone number (on a mobile device) can initiate a phone call. In order to ensure there is a web event to track, monitor, record, and report when a telephone number is clicked, the system modifies the telephone number to make the number's text an anchor tag link (URI or hypertext reference)—by constructing an anchor tag around the formatted telephone number that initiates a telephone call on the mobile device. The protocol used to initiate a telephone call on a particular mobile device can vary. The IANA recognized protocol is “tel:”, however, other protocols may apply to other devices. The hypertext reference (destination URI) of this link is constructed using the phone number and the appropriate telephone call protocol for this device, as well as any inserted tracking information.

Telephone Number Tracking

The engagement tracking system parses target webpages searching for telephone numbers (see “Text-Based Telephone Number Identification”). When a telephone number is identified, the telephone number is link-enabled (see “Link-Enabling Telephone Numbers”) and can then be tagged for tracking, monitoring, recording and reporting like any other interactive event on a webpage (see “Auto-Event-Tagging”) and tracked as a telephone call conversion event.

Image-Based Telephone Numbers

Sometimes, for design or other purposes, it is preferable to web page authors to display a telephone number as an image rather than as HTML text. These images cannot be recognized in the same way as a text telephone number. However, through other methods such as OCR, the system can also identify and tag these telephone numbers like any other telephone number on the webpage or content source (see “Phone-Number-Enabling”).

In some cases, the system identifies the name of the image through configuration—either by automatically identifying the name, identifier, or source of the image. The destination number for the telephone call link can be configured via the hosted user interface so that the image telephone number can be phone-number-enabled just like a text-based telephone number.

In other cases, the phone number image can be identified through OCR or similar technology. By analyzing images on the website (either in real-time or at an earlier time or periodic scan), text within the images on the website can be identified and compared to known telephone number formats (see “Text-Based Telephone Number Identification”). When a telephone number is identified, the image can be wrapped with a link and the destination telephone number can be determined through the text rather than configuration (see “Telephone-Number-Enabling”).

Desktop Telephone Calling

Though initiating telephone calls from a desktop browser is not default behavior, this can be done using various technologies including software installed as an executable (such as Skype) or web-based “call-back” solutions. The engagement tracking system can be used to replace text or image-based telephone numbers on a desktop computer with appropriate links for available/selected telephone call software. The same process can be used for link-enabling telephone numbers and image telephone numbers, but for browsers identified as desktop (or non-mobile) the link and protocol may be different—depending on the software and/or application.

Mobile Identification and Protocol Selection

There are various ways of identifying a mobile device and mobile browser—one of which is to use the HTTP_USER_AGENT provided by the web browser with each request to identify the device and browser and then determine its capabilities. The system may leverage specific abilities and protocols attributed to specific browser types. Browsers can be classified as Desktop, Mobile, Tablet, and so forth. In addition, common databases (Device Description Repositories (DDRs)) may be used to lookup these capabilities based on the user agent.

Telephony Detail Linking

The description herein describes how calls can be identified by link-enabling telephone numbers and/or images—and auto-event tagging those links—regardless of the telephone number appearing on the website. However, additional information about that caller can be obtained by the system by utilizing an optional tracking number—a dedicated telephone number that replaces the phone number on the webpage or content source. When a telephone call is identified on the telephony system, the call can be associated to the “phone number click” event that was recorded through the event tracking. This association can be performed using the time of the call and its proximity to the time of the click event. In this manner, the caller's phone number and the duration of the call (and other information)—can be appended to that event.

Client-Side Post-Back Tracking

Some tracking software systems (such as Google Analytics) allow for the tracking of an event through a post-back URL. This is a URL that has a conversion event tracking code implemented and that URL is called remotely from a third-party server when an event occurs—such as a telephone call. However, a problem with this form of tracking is that the third-party server calling the post-back URL does not have access to the cookies and local browser information of the visitor who initiated the event. The engagement tracking system can load a post-back URL with an image, iframe or other element within the current webpage—allowing the event to be fully tracked by software utilizing cookies and/or browser information. In addition, through a remote procedure call, the system can detect a telephone call initiated on a remote telephony system, and load a post-back URL—thereby associating the telephone call to the actual visitor session on the website—including any cookie/browser details.

Other Communication Types

Although telephone numbers and calls are used in examples herein, the engagement tracking system can be employed to track a variety of communication types. Modern devices include a number of communication methods, such as Apple's iMessage and FaceTime, other providers' instant messaging, voice and video calling, or other solutions, and so forth. These include a variety of text, audiovisual, voice, and other communication types. For each of these types of communication, they are typically initiated by some user action (often by clickable hyperlinks or other methods) that can be tracked by the addition of tracking code to the action that initiates the communication. In this way, the engagement tracking system can provide a comprehensive report to business describing how users are engaging with the business.

Example Implementation

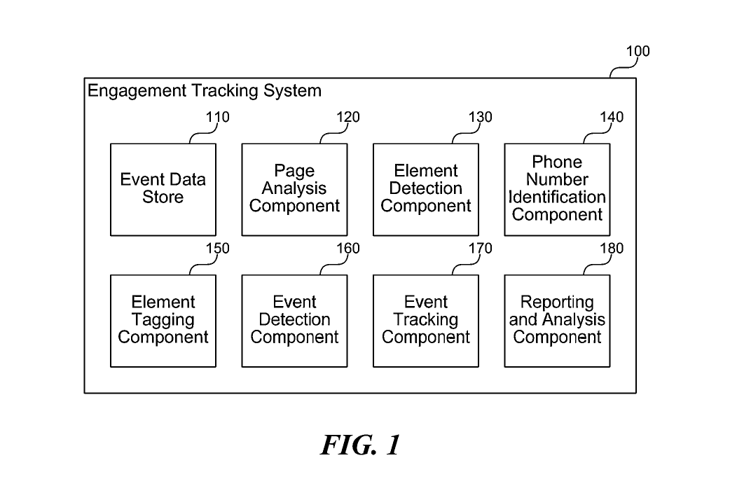

FIG. 1 is a block diagram that illustrates components of the engagement tracking system, in one embodiment. The system 100 includes an event data store 110, a page analysis component 120, an element detection component 130, a phone number identification component 140, an element tagging component 150, an event detection component 160, an event tracking component 170, and a reporting and analysis component 180. Each of these components is described in further detail herein.

The event data store 110 is a data storage facility that stores information describing one or more occurrences of one or more identified events on a web page or other user interface. The information in the data store 110 provides tracking of each event in a manner that can provide later reporting and analysis of how users are interacting with a user interface. For example, the data store 110 may track clicks, emails, calls, or other interactions that occur with a web page or other user interface. The system may also store information about the source of the visitor/user—what site the user came from, what keyword the user searched on, what online campaign drove the user to the site, and so forth. This provides a marketing aspect to the tracked information that is useful to marketers and advertisers to track the success of online campaigns. The event data store 110 may include one or more files, file systems, hard drives, databases, cloud-based storage services, or any other data storage facility for persisting data over time. The other components of the system 100 ensure that each possible event within a user interface produces an entry in the event data store 110 that allows each occurrence of the events available within the user interface to be tracked, analyzed, and reported on.

The page analysis component 120 executes when a web page or other user interface loads to associate event tracking logic with one or more events that can occur during interaction with the user interface. In some embodiments, a developer or other user adds a reference to a tracking script to the bottom of each web page associated with a website. When a page loads, the script runs and the script contains software code that analyzes the web page to identify elements that represent interaction events that are possible with the user. The page analysis component invokes the element detection component 130, phone number identification component 140, and other components of the system 100 to identify interaction elements of a web page or other user interface and to associate tracking logic with each element so that when a user interacts with the element, the tracking logic will record the occurrence of the interaction in the event data store 110.

Analysis of web pages or other user interfaces may occur on the client, the server, or other location. In some embodiments, the page analysis component 120 is embodied within a script on the page that runs on the client, whether the client is a desktop computer, laptop computer, smartphone, tablet computer, or other computing device. For example, the component 120 may run as a JavaScript script that runs within the client's web browser program. Alternatively or additionally, page analysis may occur using a server side component that operates when a page loads or statically before a page is requested to insert tracking code. Regardless of where the page analysis occurs, in some embodiments the system 100 performs page analysis without asking the user to identify any interaction elements. Thus, by the simple action of adding a reference to a page analysis script to the bottom or a page, the user can cause the system 100 to automatically identify each of the interaction elements available within the web page or other user interface, and thus the user can receive advanced tracking of each interaction event without the burden of manually identifying each trackable event on the page. This provides incredible value to organizations, reduces the time needed to add tracking to an existing web site or other application, and reduces errors that could cause some events to be missed in a manual process. In addition, this is of additional value to organizations that do not have easy access to their website code or do not have developers on staff. For example, a Wordpress site can be modified to include a script (manually or with a plugin) but adding tracking to various trackable events would be much more difficult in a Wordpress environment.

The element detection component 130 scans a web page or other user interface to identify each interactive element within the web page that a user can invoke to interact with the page. The page analysis component 120 invokes the element detection component 130 to find elements within a page and tag the found elements with tracking logic. The element detection component 130 may use a variety of techniques to identify elements, such as loading a document object model (DOM) available via the web browser in which the page analysis script is running and looking for particular object types (e.g., anchor tags, mailto links, form submit logic, and so forth). In other embodiments, the component 130 may use regular expressions or other text analysis techniques to find particular keywords or other identifiers within the web page that accompany known interaction elements. For example, for hypertext markup language (HTML) user interfaces, interaction elements have well known HTML tags that can be searched for within the page.

Interactions may also include simply viewing a web page, and the tracking script provided by the system may add logic to a web page or other user interface that tracks the fact that a user is viewing a web page, how long the user stays on the web page, whether the user scrolls to various parts of the web page, how the user was referred to the web page, and other details in addition to actions the user takes in response to viewing the web page. Thus, viewing the web page and all of the user's behavior with respect to the web page can be considered a trackable interaction, and can be captured by the system.

The phone number identification component 140 is a specialized element detection component for detecting telephone numbers within a web page or other user interface that can be called. Although phone numbers often have a readily identifiable text format, they are often not called out within the text of a user interface by any particular hypertext tag or other identification. Thus, the phone number identification component 140 uses text search, regular expressions, and other techniques to find text within the user interface that fits the format of a telephone number. Telephone numbers may be numeric, alphabetic, or alphanumeric. For example, phone numbers often are written as easily remembered words when the numbers of the phone number spell something. In addition, phone numbers may have varying formats based on the country or other jurisdiction being called. The component 140 may detect phone numbers in the format of various countries, and may use information such as a country code associated with the web browser to search for phone numbers in a format associated with the user's current locality.

Upon completion of the phone number identification component's 140 detection activity, the phone numbers within a web page or other user interface are identified and tagged with tracking logic just like any other interaction element within the user interface. Calls as used herein may refer to telephony calls made by any of a variety of traditional or modern methods. For example, a phone call may include picking up a landline phone and placing a call, using a smartphone or other cellular phone to wirelessly make a call, using modern computer applications like Skype or Google Voice to make calls, using upcoming methods like WebRTC built into a browser, and so forth. To the extent that the system can track these events, the system adds tagging to the web page or other interface to detect when a user makes a call based on a number or other identifier that the user found on the web page.

The element tagging component 150 adds tracking logic to each identified interaction element within a user interface. Tracking logic may include an embedded script, associated handler (e.g., OnClick or OnSubmit event handler for a particular DOM element), or other logic that will be executed by the user's web browser or other entity upon interaction with an interaction element by the user. The element tagging component 150 may create a category in the form of a substantially unique identifier that allows each event within a website or other application to be individually identified. In other words, upon the occurrence and tracking of an event a user can later know based on the recorded tracking information exactly which interaction element within the application was triggered or interacted with by another user. In some embodiments, the component 150 associates logic with each interaction element that writes an entry to the event data store 110 when a user interacts with the element. The entry includes the category or other identifier associated with the element.

The event detection component 160 detects occurrences of previously tagged events. In circumstances where the event tagging logic added a DOM handler to a page element, the event detection component 160 detects the invocation of the handler. For example, if a user clicks on a button within the user interface that has an associated OnClick DOM handler, the browser automatically invokes the OnClick handler when the user clicks on the button. In other circumstances, the tagging logic may embed logic directly within the page, such as by hooking a link to go to an intermediate link with tracking logic before navigating to the link originally intended by the user. The system 100 can use a variety of methods of tagging events and then subsequently detecting the occurrences of those tagged events. Upon detection of a tagged event, the system 100 invokes the event tracking component 170 to create a record of the occurrence of the event within the event data store 110.

The event tracking component 170 records each occurrence of an interaction event as a result of the user interacting with the user interface. When the event detection component 160 detects an occurrence of a tagged event, the component 160 invokes logic that writes an entry in the event data store 110 to record the occurrence of the event. For example, the logic may write a row in a database table of the event data store 110. The row may include information such as the time of occurrence of the event, a substantially unique identifier associated with the event, a category of the event, the user that caused the event, and other information associated with the event. The information might also include attributes of the visitor's device and/or browser, and the source of the visitor—such as whether they arrived on the user interface via Google, Bing, or some other referring site—and even the keyword or campaign on the search engine that referred them.

The reporting and analysis component 180 allows an administrator of a website or other application to view one or more reports and analysis based on the recorded occurrences of events associated with the website. The system may provide various automated reports as well as automated analysis to help administrators of websites understand how users are interacting with and engaging with the websites. The analysis and reporting may include a categorization of recorded events that identify interaction events by type, purpose, page, or other useful metrics and delineations.

The computing device on which the engagement tracking system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

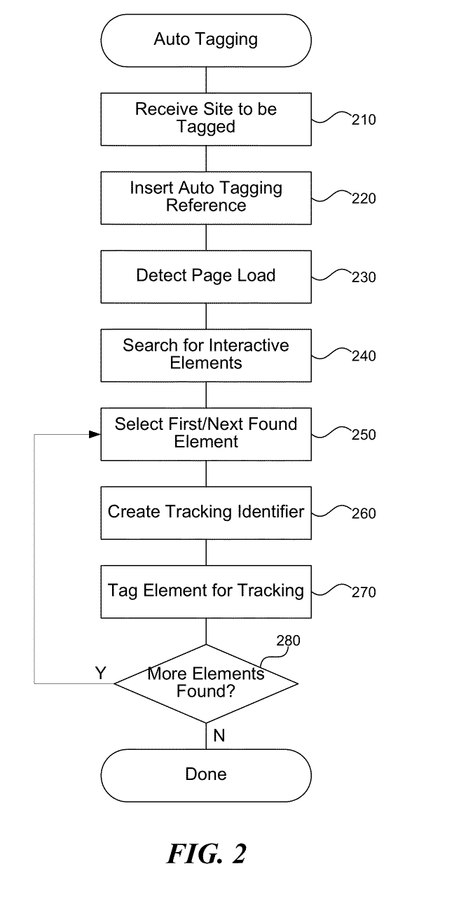

FIG. 2 is a flow diagram that illustrates processing of the engagement tracking system to automatically tag interaction events in a web page, in one embodiment. Beginning in block 210, the system receives an identification of a website to be automatically tagged to track interaction events between users and one or more pages of the website. The system may receive a uniform resource locator (URL) or other identification of a website that an administrator or other user wants to prepare for tracking interactions. In some embodiments, administrators of websites may create a profile or other stored record with the system that identifies the website, one or more administrators, and allows the administrators to access advanced features of the system such as analysis and reporting of recording tracking information. The profile may associate the administrators with the websites they are allowed to manage tracking information for.

Continuing in block 220, the system inserts one or more references to an automatic tagging script to at least one web page of the identified web site, wherein the automatic tagging script contains logic for automatically identifying and adding tracking information to one or more elements of the web page that a user can interact with. The tagging script reference is a simple line of HTML or other software code that can be the same for each web page and can be easily added by administrators without major editing of the web page or altering the web page's main functionality and purpose. Rather than administrators or developers manually reviewing each page to identify interactive elements one by one, the administrators need only add the tracking script reference to the page, and the system will do the work of finding interactive elements and tagging them for tracking. Alternatively or additionally, the system may identify elements via reverse proxy, which is an approach where a webserver or intermediate webserver is setup to automatically add HTML or other software code to every page that passes through. This can often be done without modification of the original web pages but rather through routing domain name system (DNS)/domain names through intermediate proxy servers.

Continuing in block 230, the system detects that a web page has been loaded by a user and invokes the inserted reference to the automatic tagging script to run the script. A user requests the web page by visiting the web page in a web browser, either by following a link, typing the page's URL in the browser's address area, or some other method of navigating to a web page. The user's browser then loads the page, and in the process of loading the page invokes any script, such as JavaScript, contained within the page that is specified to run at page load time. This includes the inserted automatic tagging script, so upon page load the script identified by the reference executes. The body of the script may be located in a separate file (e.g., a .JS file) or other location to keep the reference small and easy to insert, or may also be embedded directly within the web page.

Continuing in block 240, the system automatically searches the loaded web page for one or more elements within the web page with which the user can interact to perform actions. For example, the system may identify HTML anchor tags, form submit logic, specific link types (e.g., mailto), buttons, file download links, video, pictures, internal or external links, or any other interactive elements that the user can interact with. These elements may change the state of the page, take the user to a different page, navigate the user to another site, initiate a phone call or email, and so forth. In some embodiments, the system performs a targeted search, described in detail herein, for phone numbers within the web page that the user can place a call to. Although they are sometimes detected differently, phone numbers are like any other interactive element once found and tagged. The search for interactive elements may use an HTML or other document object model (DOM), parsing of text for particular elements, regular expressions, and other techniques for finding interactive elements within the text or other content that defines the web page.

Continuing in block 250, the system selects the first interactive element identified by the search of the loaded web page. During subsequent iterations, the system selects the next interactive element. Although shown serially for ease of illustration, those of ordinary skill in the art will recognize that the processing of identified interactive elements can occur in parallel for performance, efficient use of computing resources, or other reasons.

Continuing in block 260, the system creates a tracking identifier that identifies the selected interactive element and that will be associated with any detected occurrences of interactions with the selected interactive element. The tracking identifier may be numeric, alphanumeric, a globally unique identifier (GUID), or any other identifier that can distinguish interaction with one element from another. Tracking identifiers may be unique within a particular web page, web site, or globally unique across web sites. The tracking identifier allows the system to understand and report which particular events occurred during reporting and analysis of tracked user engagements with a website.

Continuing in block 270, the system tags the selected interactive element for tracking so that when a user interacts with the element, a tracking record will be created that stores the occurrence of the interaction. Tagging may include inserting additional script into the web page that invokes logic to create the tracking record. For example, many web browsers allow the attachment of handlers to particular page elements in a document object model (DOM), such as an OnClick handler associated with elements that can be clicked with a mouse or other pointing device or input (e.g., touch input). Alternatively or additionally, the system may replace links with intermediate tracking links that store the tracking information and then redirect to the original destination of the link being tracked.

Continuing in decision block 280, if more interactive elements were found during the search, then the system loops to block 250 to process the next element for tracking, else the system completes. After block 280, these steps conclude. Upon completion of these steps, the web page is ready for tracking of any interaction with the interactive elements of the web page. The user will view the page for some amount of time, interact with various elements of the page, and the system will record a tracking record of each interaction.

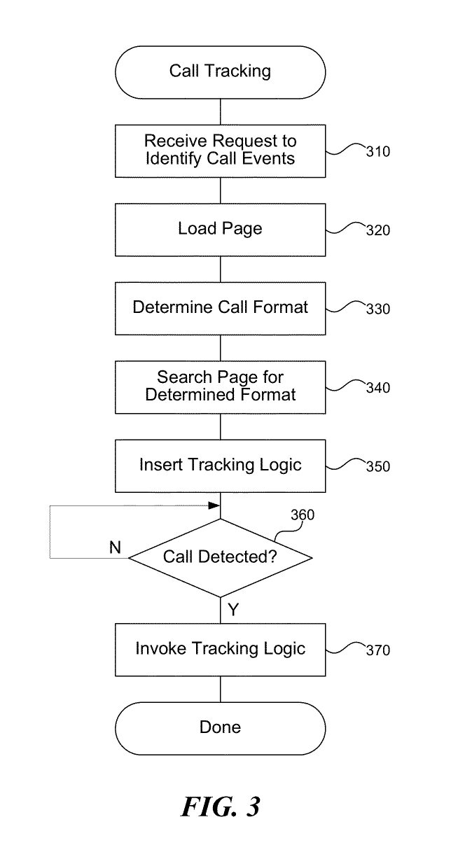

FIG. 3 is a flow diagram that illustrates processing of the engagement tracking system to track telephone calls made in response to a web page, in one embodiment. Telephone calls that result from a web page or other computing interface have traditionally been difficult to track or associate with the web page that produced the call. An organization can ask callers how they heard about the organization or perform other manual methods of tracking, but it is more reliable to automatically detect that the user initiated a call upon viewing a website with the phone number. Today's mobile devices often have calling capability (e.g., smartphones) and highlight phone numbers so they can be clicked and called with cellular or other hardware available on the same computing device displaying the web page. In addition, desktop and other traditional computing systems are also gaining calling capabilities through the rise of telephony applications such as Skype and Google Voice. These applications allow calls to be made from a computing device connected to the Internet or other network. Moreover, newer initiatives like WebRTC are pushing for telephony functionality to be built directly into web browsers, such that the browser can request direct access to hardware such as microphones, speakers, and webcams for making calls.

Beginning in block 310, the system receives a request to identify call events on a web page. The tracking script described earlier that is added to a web page may include logic for identifying call events on a web page. A call event can be any specification of a phone number, and may simply be text on the web page that is not otherwise tagged or called out as a phone number. However, the system can detect that it is a phone number based on the format of the text or other methods. The system may also receive an identification of a particular web page for which an administrator or other user wants to track calls related to the web page.

Continuing in block 320, the system loads the page during a request to view the page. For example, a user may open the web page in a web browser using a desktop, laptop, mobile, or other computing device. As the page loads, the web browser invokes any scripts associated with the page that are specified to run at page load, including the automatic tagging script described herein. The system may include a specific script for tagging phone numbers or may include a unified script that detects phone numbers and other interactive elements as described above.

Continuing in block 330, the system determines a call format that signals the presence in text of a phone number. The system may apply a locality filter that determines a call format specific to the user's current locality (or the locality specific to the website/page), or may detect phone numbers across a variety of possible number formats. The system may allow phone numbers to have alphabetic characters, such as vanity numbers that include a word or other memorable combination of letters. The format may include specifying placement of punctuation or other characters, such as parentheses, dashes, periods, or other common phone number separating characters. The format may also specify a quantity of numbers to be found together (e.g., seven for U.S. numbers without area codes, or ten with area codes), as well as detecting user attempts to avoid spam by spelling out numbers (e.g., “5five5-1twoone2”).

Continuing in block 340, the system searches the web page for phone numbers that match the determined call format. The system may apply regular expressions or other computational text search techniques that allow specifying a variety of text formats to be found. The system may leverage a document object model (DOM) to search text within particular portions of a web page (e.g., the body), or may search the entire text of the web page to find phone numbers. The system may also apply a scoring or other weighting technique to quantify confidence that a particular detected number is a phone number.

Continuing in block 350, for each identified phone number, the system inserts tracking logic for detecting user interaction with an identified telephone number. The system may convert the text-based phone number to an anchor tag or other link that invokes the tracking logic as well as enabling calling capabilities of the computing device. For example, the system may create a link that invokes cellular or other telephony hardware or software of the computing device. The system also associates a tracking script with the created link, so that when a user clicks or otherwise interacts with the link to make a call, the tracking script can store a record of the user requested call. The inserted tracking logic may include an identifier, such as that described above, to identify the particular interaction or page element that led to the call.

Continuing in decision block 360, if the system detects an interaction from a user with an identified telephone number with associated tracking logic, then the system continues at block 370, else the system loops to block 360 to wait for the user to attempt a call.

Continuing in block 370, upon detecting that the user has interacted with a telephone number link, the system invokes tracking logic to store a record of the interaction, and then forwards the user request on to hardware or software of the computing device to perform a call to the selected telephone number. The tracking logic may store information such as the time of the interaction, the web page from which the interaction occurred, the user performing the interaction, an identifier associated with the linked phone number, and so forth. The system may also store information about the source of the visitor/user—what site the user came from, what keyword the user searched on, what online campaign drove the user to the site, and so forth. This provides a marketing aspect to the tracked information that is useful to marketers and advertisers to track the success of online campaigns. This information is stored in an event data store from which analysis and reporting can later be performed by an administrator or other user. The captured information allows the administrator to connect phone call events with the web pages that led the user to make the call as well as details about the user's device, network, or browsing habits. After block 370, these steps conclude.

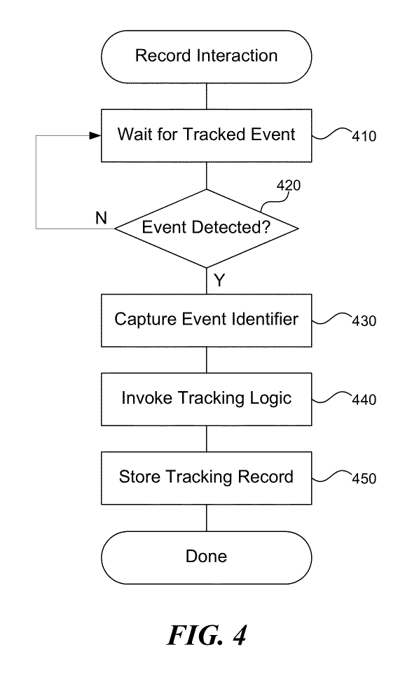

FIG. 4 is a flow diagram that illustrates processing of the engagement tracking system to record an interaction that occurs after a web page has been automatically tagged to track interaction events, in one embodiment. Beginning in block 410, the system waits for a tracked interaction event to occur. A tracked interaction event is one that has been previously tagged by a process such as that described with reference to FIG. 2. The system may load and display a web page to a user, and then wait for the user to interact with one of the tracked elements of the web page, such as by clicking links, buttons, or other elements of the page.

Continuing in decision block 420, if the system detects user interaction with a tagged interactive element of the web page, then the system continues at block 430, else the system loops to block 410 to wait for an interaction to occur. The system waits for such interactions for as long as the web page is loaded and the user is viewing the web page.

Continuing in block 430, the system captures an event identifier associated with the detected user interaction with the tagged interactive element of the web page. During automatic tagging of the web page, the system associates an identifier with each interactive element of the page to be tracked. This identifier is then available when the tracked event occurs so that the tracking logic inserted by the system can capture the identifier and store it in the event data store.

Continuing in block 440, the system invokes tracking logic automatically associated by the system with the tagged interactive element. The tracking logic connects the event data store to capture and store information about the detected user interaction in the event data store. The captured information includes the captured event identifier, and may include other information such as the time of the interaction, user details, other details about the circumstances of the interaction, and so forth.

Continuing in block 450, the system stores a tracking record in an event data store that records the occurrence of the detected user interaction for subsequent analysis by an operator of the web page. The tracking record forms a historical account of user interactions with the web page and allows the website operator to later perform analysis and draw conclusions from how users are using the web page and/or what marketing or web presence is driving visitors to their page. This allows the operator to measure user engagement, determine which parts of a web page are most effective, determine what marketing relationships are most effective, and so on. After block 450, these steps conclude.

The following figures show several screenshots produced by one embodiment of the engagement tracking system, and demonstrate various user interfaces associated with the system.

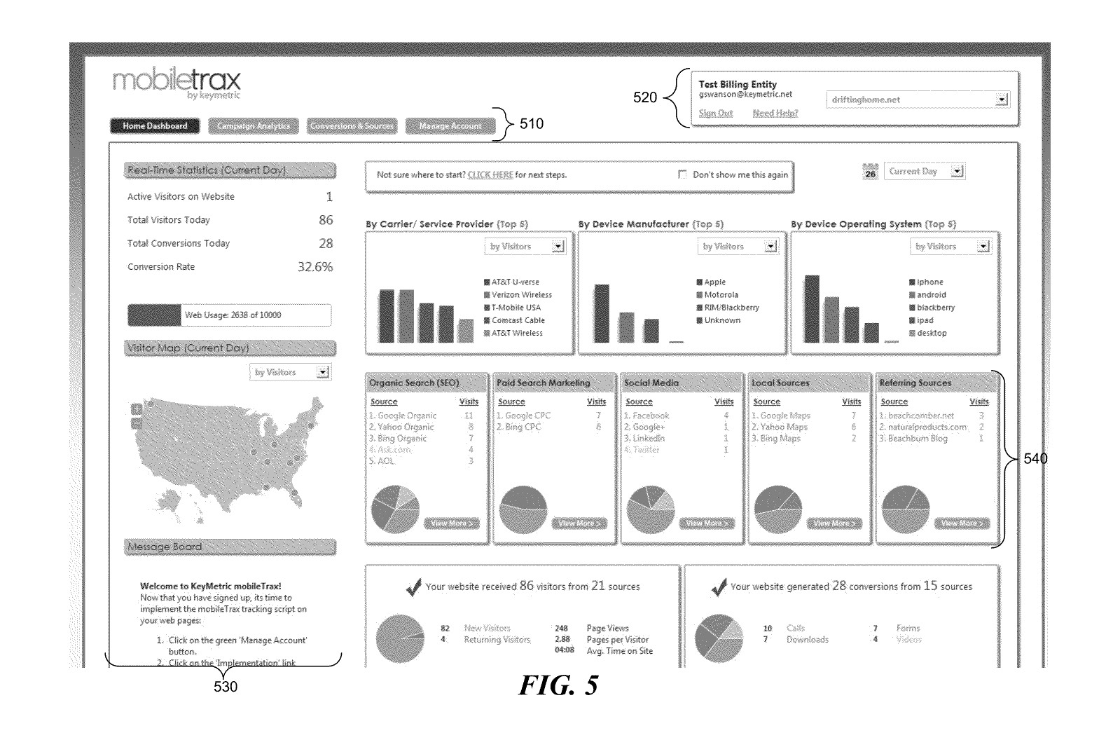

FIG. 5 is a display diagram that illustrates a dashboard of the engagement tracking system, in one embodiment. In some embodiments, each customer of the system, which may represent a marketer associated with a website or organization or administrator of the website, has a profile stored with the system that stores various information identifying the customer, views of data associated with the customer, past tracked events for websites associated with the customer, and so forth. This profile information allows the system to display a dashboard, like that shown in FIG. 5, when the customer visits an administrative website provided by the system, and to present useful information to the customer. The dashboard displayed in FIG. 5 provides a variety of breakdowns of visitors and events related to a website associated with the customer viewing the dashboard. For example, the dashboard includes buttons 510 for navigating to various information that can be displayed, profile information 520 identifying the currently logged in customer, real-time information 530 about visitors currently using the customer's website, and sources 540 of visitors to the website during a particular time period.

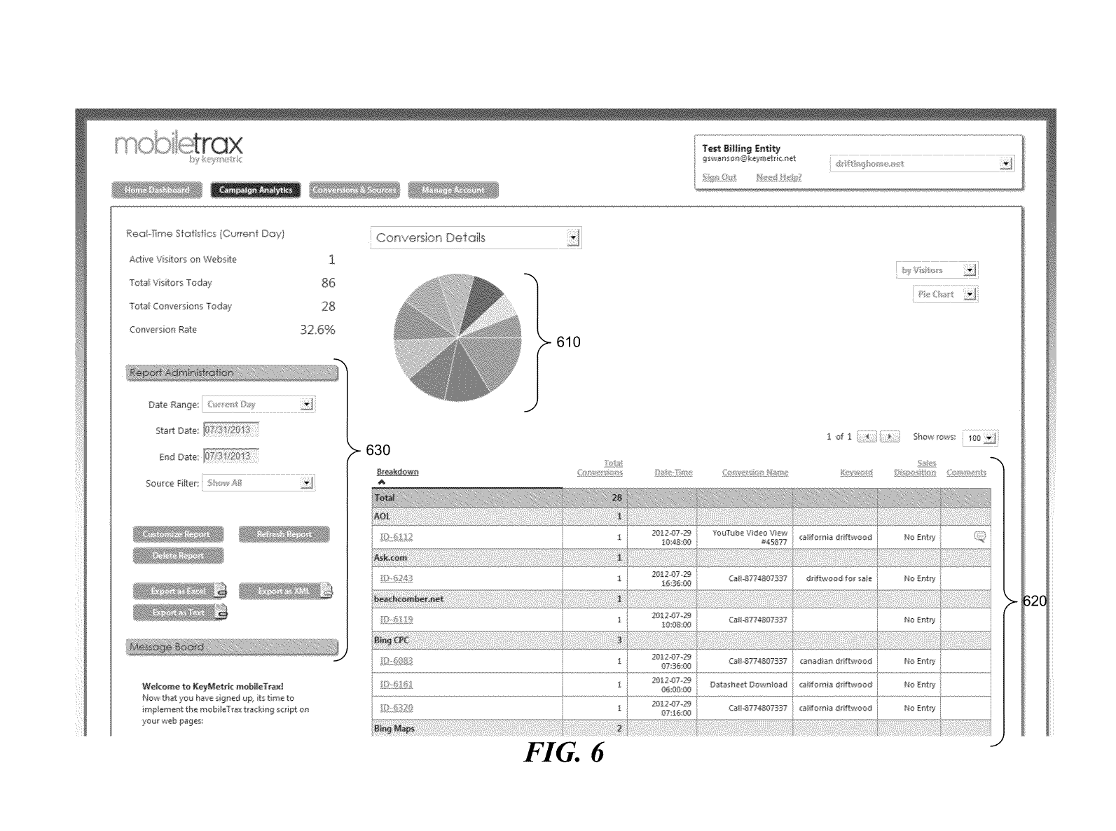

FIG. 6 is a display diagram that illustrates a sample report generated by the engagement tracking system, in one embodiment. A customer might reach the report by selecting one of the navigation buttons in FIG. 5 to display campaign analytics. The sample report shows various events tracked for a particular website and how the events are attributed to various sources. The report may include graphical information 610, such as the displayed pie graph, tabular information 620, such as the table listing sources, and one or more controls 630 for modifying the displayed report.

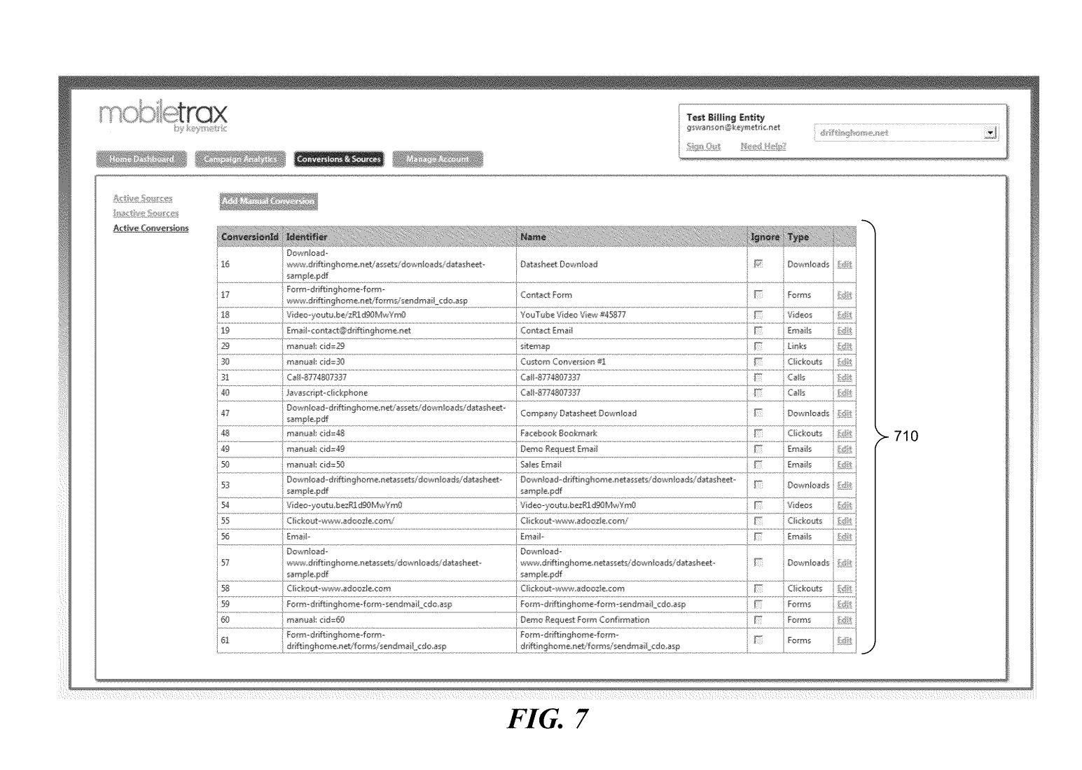

FIG. 7 is a display diagram that illustrates a sample list of events generated by the engagement tracking system, in one embodiment. A customer might reach the list of events by selecting one of the navigation buttons in FIG. 5 to display conversions and sources. The list 710 includes each of the events that have been detected and stored for the customer's website—along with the categories and names that were assigned by users.

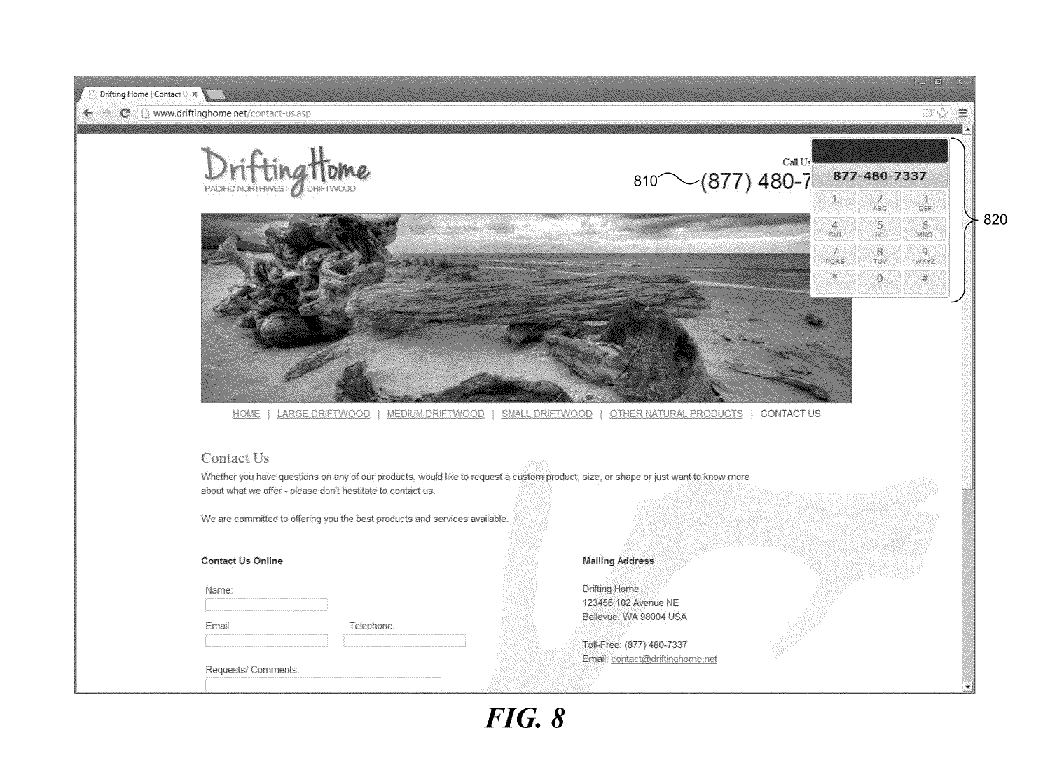

FIG. 8 is a display diagram that shows a working example of how WebRTC might be used in a website to initiate a phone call directly in the browser itself, in one embodiment. The display is produced by a recent version of the Google Chrome web browser, which includes built in WebRTC-based telephony features. The web page displayed by the browser includes a telephone number 810, and the browser provides a pop-up dial pad 820 that allows the user to call the number (either manually or by pre-filling the number when the user selects it). the browser uses hardware attached to the user's computing device, such as a microphone, speakers, and possibly a web camera (for video calling) to capture information for the call, and then uses an Internet or other network connection to place the call (e.g., using Voice over IP (VoIP)).

From the foregoing, it will be appreciated that specific embodiments of the engagement tracking system have been described herein for purposes of illustration, but that various modifications may be made without deviating from the spirit and scope of the invention. Accordingly, the invention is not limited except as by the appended claims.

I/We claim:

1. A computer-implemented method to automatically tag interaction events in a web page, the method comprising:
receiving an identification of a website to be automatically tagged to track interaction events between users and one or more pages of the website;
inserting one or more references to an automatic tagging script to at least one web page of the identified web site, wherein the automatic tagging script contains logic for automatically identifying and adding tracking information to one or more elements of the web page that a user can interact with;
detecting that a web page has been loaded by a user and invoking the inserted reference to the automatic tagging script to run the script;
automatically searching the loaded web page for one or more elements within the web page with which the user can interact to perform actions; and
for each of a set of identified interactive elements found by searching the web page,
creating a tracking identifier that identifies the selected interactive element and that will be associated with any detected occurrences of interactions with the selected interactive element; and
tagging the selected interactive element for tracking so that when a user interacts with the element, a tracking record will be created that stores the occurrence of the interaction,
wherein the preceding steps are performed by at least one processor.

2. The method of claim 1 wherein receiving the identification of the website comprises an administrator creating a profile with a tracking system that identifies the website, wherein the profile associates the administrator with the website.

3. The method of claim 1 wherein inserting one or more references to the automatic tagging script comprises adding a line of hypertext markup language (HTML) code that is the same for each web page to be tracked to each web page to be tracked.

4. The method of claim 1 wherein inserting one or more references to the automatic tagging script comprises avoiding administrators and developers manually reviewing one or more web pages to identify interactive elements one by one and instead using the automatic tagging script to automatically find interactive elements and tagging the interactive elements for tracking.

5. The method of claim 1 wherein detecting that a web page has been loaded comprises detecting that a user has visited the web page in a web browser and in the process of loading the page invokes any script contained within the page that is specified to run at page load time, including the inserted automatic tagging script.

6. The method of claim 1 wherein automatically searching the loaded web page comprises identifying at least one of hypertext markup language (HTML) anchor tags, form submit logic, mailto links, buttons, file download links, video, pictures, internal links, and external links that the user can interact with.

7. The method of claim 1 wherein automatically searching the loaded web page comprises adding logic for tracking the act of a user viewing a web page.

8. The method of claim 1 wherein automatically searching the loaded web page comprises performing a targeted search for phone numbers within the web page that the user can place a call to and tagging the phone numbers to track calls placed in response to viewing the web page.

9. The method of claim 1 wherein automatically searching the loaded web page comprises using a hypertext markup language (HTML) document object model (DOM) to identify specific HTML elements within the web page.

10. The method of claim 1 wherein creating the tracking identifier comprises creating an alphanumeric identifier that can correlate an occurrence of an event with a location on a web page from which the event flowed to determine user engagement with the web site.

11. The method of claim 1 wherein tagging an interactive element comprises inserting additional script into the web page that invokes logic to create the tracking record.

12. The method of claim 1 wherein tagging an interactive element comprises replacing links with intermediate tracking links that store the tracking information and then redirect to the original destination of the link being tracked.

13. A computer system for automatic tracking of user engagement with computing interfaces, the system comprising:
a processor and memory configured to execute software instructions embodied within the following components;
an event data store that stores information describing one or more occurrences of one or more identified events on a web page;
a page analysis component that executes when a web page loads to associate event tracking logic with one or more events that can occur during interaction with the web page;
an element detection component that scans a web page or other user interface to identify one or more interactive elements within the web page that a user can invoke to interact with the page;
an element tagging component that adds tracking logic to each identified interactive element within the web page;
an event detection component that detects occurrences of previously tagged events based on a user interacting with the web page;
an event tracking component that records one or more occurrences of interaction events as a result of the user interacting with the web page; and
a reporting and analysis component that allows an administrator of a website to view one or more reports and analysis based on the recorded occurrences of events associated with the website.

14. The system of claim 13 wherein the page analysis component operates when a web page loads to automatically analyze the web page to identify elements that represent interaction events that are possible with the user by invoking the element detection component.

15. The system of claim 13 wherein the page analysis component automatically performs page analysis without asking the user to manually identify any interaction elements, such that by causing the page analysis component to be invoked, the user can cause the system to automatically identify one or more of the interactive elements available within the web page and can receive advanced tracking of one or more interaction events without the burden of manually identifying each trackable event on the page.

16. The system of claim 13 wherein the element detection component further comprises a phone number identification component for detecting telephone numbers within a web page that can be called.

17. The system of claim 16 wherein the phone number identification component searches the web page for a pattern of text that is associated with a phone number format.

18. The system of claim 13 wherein tracking logic comprises software instructions for detecting that a user is interacting with an identified interactive element of the web page and for storing a record of the interaction in the event data store.

19. A computer-readable storage medium comprising instructions for controlling a computer system to track telephone calls made in response to a web page, wherein the instructions, upon execution, cause a processor to perform actions comprising:
receiving a request to identify call events on a web page, wherein a call event is any phone number embedded within text of the web page;
loading the web page during a request to view the web page received in a web browser;
determining a call format that signals the presence in text of a phone number;
searching the web page for one or more phone numbers that match the determined call format;
for each identified phone number, inserting tracking logic for detecting user interaction with an identified telephone number;
upon detecting an interaction from a user with an identified telephone number with associated tracking logic, invoking tracking logic to store a record of the interaction, and then forwarding the user request on to hardware or software of the computer system to perform a call to the selected telephone number.

20. The medium of claim 19 wherein inserting tracking logic for detecting user interaction with an identified telephone number comprises replacing an identified phone number with a tracking phone number, the calling of which informs the system of a link between the web page where the phone number was found and the call made by the user.
